(19) United States
(12) Patent Application Publication
(10) Pub. No.: US 2023/0294729 A1
(43) Pub. Date: Sep. 21, 2023

(54) METHOD AND SYSTEM FOR ASSESSMENT OF SENSOR PERFORMANCE

(71) Applicant: FORESIGHT AUTOMOTIVE LTD., Ness Ziona (IL)

(72) Inventors: Omri DANZIGER, Kfar Vradim (IL); Ivgeny KOPILEVICH, Rehovot (IL)

(73) Assignee: FORESIGHT AUTOMOTIVE LTD., Ness Ziona (IL)

(21) Appl. No.: 18/021,676

(22) PCT Filed: Aug. 18, 2021
(86) PCT No.: PCT/IL2021/051010

§ 371 Date: Feb. 16, 2023

Related U.S. Application Data
(60) Provisional application No. 63/066,834, filed on Aug. 18, 2020.

(51) Int. Cl. B60W 60/00; G06V 20/56; G06V 10/26

(52) U.S. Cl. CPC B60W 60/001; G06V 20/56; G06V 10/26; B60W 2420/42; B60W 2420/52

(57) ABSTRACT

A system and method of conducting a vehicle by at least one processor may include: receiving sensor data from a plurality of sensor channels associated with the vehicle; for each sensor channel, calculating a three-dimensional (3D) reconstruction data element, representing real-world spatial information, based on said sensor data; for each sensor channel, calculating a channel score based on the 3D reconstruction data element; selecting a sensor channel of the plurality of sensor channels based on the channel score; and conducting the vehicle based on the 3D reconstruction data element of the selected sensor channel.

### CROSS-REFERENCE TO RELATED APPLICATIONS

This application claims the benefit of priority of U.S. Patent Application No. 63/066,834, filed Aug. 18, 2020, and entitled: “MULTI SENSOR QUALITY ASSESSMENT USING 3D RECONSTRUCTION”, which is hereby incorporated by reference in its entirety.

### FIELD OF THE INVENTION

The present invention relates to the fields of sensor performance evaluation and resource allocation. More particularly, the present invention relates to a system and method of assessing sensor performance, and allocation of computing resources in real time.

### BACKGROUND OF THE INVENTION

Currently available systems of assistive driving may obtain real-time information from a plurality of cameras, and may need to select between these sensors in real time. Such selection is typically performed based on environmental conditions. For example, during clear daytime, a visible light (VL) camera may be used to obtain high-resolution images of the vehicle's surroundings; during nighttime an infrared (IR) camera may be preferred for that capacity; and during a condition of fog—a Radar or Light Detection and Ranging (LIDAR) sensor may be preferred. However, such selection may be both computationally wasteful and suboptimal.

For example, currently available assistive driving system may be configured to assess the quality of an image based on a proportion of the well-lit sections of the image. The use of headlights may reflect light from objects that are in close vicinity to a vehicle, yet poorly illuminate objects that may be further away, although still relevant for conducting the vehicle. Thus, headlights may illuminate most of a sensor's field of view, causing an assistive driving system to assess most of the acquired image as well-lit. In other words, headlights may brighten the image produced by VL sensors, and skew the assisted driving system toward selecting the VL sensors, even though lighting conditions of distant objects may be poor. In such conditions, currently available systems of assistive driving may: (a) use the suboptimal selected VL sensors to compute a driving path for conducting the vehicle, and (b) waste computational resources on poor, or redundant sensors.

### SUMMARY OF THE INVENTION

Therefore, a system and method for assessing performance of sensors based on three-dimensional (3D) reconstruction of the sensors' real-world environment may be required.

Embodiments of the present invention may include a method and system for assessing performance of one or more sensor channels, via a process of 3D reconstruction.

The term “sensor” may be used herein to refer to an apparatus that may be configured to provide special information regarding the apparatus' vicinity in the real world. For example, a sensor may include a VL camera, an IR camera, a stereo-camera (e.g., IR or VL), a LIDAR sensor, a radar, and the like.

The terms “sensor channel” and “sensor set” may be used herein interchangeably to refer to a group of spatial sensors that may be used to produce a 3D reconstruction of a real-world object or scene. For example, a sensor channel or set may include two separate sensors such as VL cameras, that may be arranged so as to produce stereoscopic, 3D information representing a scene, as known in the art.

According to some embodiments, each sensor channel or set may include a unique, or exclusive group of sensors. For example, a first sensor channel may include sensors A and B, whereas a second channel may include sensors C and D. As elaborated herein, embodiments of the present invention may (a) produce a first 3D reconstruction of an object or scene based on sensors A and B of the first channel; (b) and produce a second 3D reconstruction of an object or scene based on sensors C and D of the second channel; and (c) select a channel (and subsequent sensors) based on scoring of the first 3D reconstruction and second 3D reconstruction.

Additionally, or alternatively sensor channels may include non-exclusive groups of sensors. For example, embodiments of the present invention may receive spatial sensory data from sensors (e.g., cameras) A, B and C, and may be required to select an optimal combination of sensors among sensors A, B and C. Embodiments of the invention may thus define three channels: a first sensor channel may include sensors A and B, a second channel may include sensors A and C, and a third sensor channel may include sensors B and C. As elaborated herein, embodiments of the invention may proceed to produce respective three 3D reconstruction data element (e.g., a 3D reconstruction data element for each sensor channel), score the 3D reconstruction data element, and select a channel (and subsequent sensors) based on scoring of the 3D reconstruction data elements.

The term “3D reconstruction” may be used herein to refer to a process by which a shape or appearance of a real-world object or scene may be obtained. Alternatively, the term “3D reconstruction” may be used herein to refer to an outcome or product of such a process, including for example, a depth map, a point cloud and the like.

For example, embodiments of the invention may receive, from two or more cameras (e.g., a stereo camera), a plurality of image data elements. Embodiments may extract 3D information pertaining to an object or a scene depicted in the received plurality of images by using stereoscopic vision, and may produce a 3D reconstruction data element such as a depth map, as known in the art.

In another example, embodiments of the invention may receive from a radar or LIDAR sensor one or more data elements representing direction and/or distance of real-world objects from the radar or LIDAR sensor, and may produce a 3D reconstruction data element such as a point cloud, as known in the art.

According to some embodiments, the 3D reconstruction may be, or may include a data structure (e.g., a table, an image, a 2-dimensional (2D) matrix, a 3D matrix, and the like), which may convey or include the extracted 3D information. For example, the 3D reconstruction data element may be a depth map, which may be manifested as a 2D matrix or image, in which the value of each entry or pixel may represent (a) a distance from a viewpoint (e.g., a sensor) to a surface in the depicted scene; and (b) a direction from the viewpoint to the surface in the depicted scene.

Embodiments of the invention may include a method of conducting a vehicle by at least one processor. Embodiments of the method may include receiving sensor data from a plurality of sensor channels associated with the vehicle; for each sensor channel, calculating a three-dimensional (3D) reconstruction data element (e.g., a depth map or a point cloud) representing real-world spatial information, based on said sensor data. For each sensor channel, embodiments, may calculate a channel score based on the 3D reconstruction data element and select a sensor channel of the plurality of sensor channels based on the channel score. Embodiments of the invention may subsequently conduct the vehicle based on the 3D reconstruction data element of the selected sensor channel.

According to some embodiments, selecting the sensor channel may be done iteratively, where each iteration pertains to a specific time frame. In each time frame, the vehicle may be conducted based on the 3D reconstruction data element of the selected sensor channel in that time frame.

According to some embodiments, at each time frame: (a) the 3D reconstruction data element of the relevant selected sensor channel may represent real-world spatial information in a first resolution or quality, and (b) the 3D reconstruction data element of at least one other, second sensor channel may represent real-world spatial information in a second, inferior resolution. The term “inferior” may be used herein in the context of resolution to infer that a numerical representation of the 3D reconstruction data element, of the second channel may have inferior accuracy e.g., be represented by a smaller number of data bits.

According to some embodiments, conducting the vehicle may include computing a driving path based on the 3D reconstruction data element of the selected sensor channel; sending the driving path to a computerized autonomous driving system, adapted to control at least one property of motion of the vehicle; and conducting the vehicle by the computerized autonomous driving system, based on said computed driving path.

According to some embodiments, the at least one property of motion may be selected from a list consisting of: speed, acceleration, deceleration, steering direction, orientation, pose and elevation.

According to some embodiments, calculating a channel score may include segmenting the 3D reconstruction data element to regions; for each region, calculating a region score; and aggregating the region scores to produce the channel score.

According to some embodiments, calculating the region score may include receiving a relevance map, associating a relevance score to one or more regions of the 3D reconstruction data element; calculating, based on the 3D reconstruction data element, a real-world size value, wherein said real-world size value represents a size of a real-world surface represented in the relevant region; and calculating the region score based on the real-world size value and the relevance map.

For example, embodiments of the invention may calculate, for one or more regions of the 3D reconstruction data element a confidence level value, and may calculate the region score of a specific region based on the relevant region's confidence level value.

Embodiments of the invention may apply a machine-learning (ML) based object recognition algorithm on the sensor data to recognize at least one real-world object. Embodiments of the invention may label or associate the at least one real-world object to one or more regions of the 3D reconstruction data element; and calculating the region score of a specific region further based on the association of relevant regions with the at least one real-world object.

Embodiments of the invention may include receiving spatial sensor data from a plurality of sensors, wherein each sensor may be associated with one or more sensor channels.

Embodiments of the invention may include a system for conducting a vehicle. Embodiments of the system may include: a computerized autonomous driving system, adapted to control at least one property of motion of the vehicle; a non-transitory memory device, wherein modules of instruction code may be stored; and at least one processor associated with the memory device, and configured to execute the modules of instruction code.

Upon execution of said modules of instruction code, the at least one processor may be configured to: receive sensor data from a plurality of sensor channels associated with the vehicle; for each sensor channel, calculate a 3D reconstruction data element, representing real-world spatial information, based on said sensor data; for each sensor channel, calculate a channel score based on the 3D reconstruction data element; select a sensor channel of the plurality of sensor channels based on the channel score; and conduct the vehicle by the computerized autonomous driving system, based on the 3D reconstruction data element of the selected sensor channel.

Embodiments of the invention may include a method of conducting an autonomous vehicle by at least one processor. Embodiments of the invention may include receiving spatial data from a plurality of sensor channels.

For each sensor channel, embodiments of the invention may: compute a 3D reconstruction data element based on the received spatial data; divide the 3D reconstruction to regions; calculate a regional score for each of said regions, based on at least one of: real-world size corresponding to the region, clarity of depth mapping of the region, and association of the region with a real-world object; and calculate a channel score. Embodiments of the invention may calculate the channel score by performing a weighted sum of the regional scores. Embodiments of the invention may subsequently select at least one sensor channel of the plurality of sensor channels based on the channel score, and conduct the autonomous vehicle based on said selection.

According to some embodiments, receiving spatial data from a plurality of sensor channels may include receiving spatial sensor data from a plurality of sensors, where each sensor may be associated with one or more sensor channels, and where calculating a channel score may include individually calculating a quality score for individual sensors of at least one sensor channel.

According to some embodiments, selecting a sensor channel may include: applying a bias function, adapted to compensate for sensor artifacts, on one or more sensor quality scores, to obtain a biased sensor quality score; comparing between two or more sensor quality scores and/or biased sensor quality scores; and selecting a sensor channel based on said comparison.

According to some embodiments, the at least one processor may: compute a weighted average of 3D reconstruction data elements of the selected at least one sensor channels, based on the channel scores; compute a driving path based on the weighted average of 3D reconstruction data elements; and conducting the autonomous vehicle according to the computed driving path.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for assessment of sensor performance, according to some embodiments;

FIG. 2 is a block diagram, depicting a system for assessment of sensor performance, according to some embodiments;

FIG. 3 is a schematic diagram depicting a top view of a scene, where multiple objects are in the field of view of an observer;

FIG. 4 is a flow diagram, depicting a method of 3D reconstruction scoring according to some embodiments of the invention;

FIG. 5 is a block diagram depicting an example of application of a system for assessment of sensor performance according to some embodiments of the invention;

FIG. 6 is a timescale diagram, depicting scoring of a VL (Visible light) channel and an IR (infra-red) channel over time, according to some embodiments of the invention;

FIG. 7 is a block diagram depicting flow of data during a process of scoring multiple sensor channels, according to some embodiments of the invention;

FIG. 8 is a block diagram depicting flow of data during a process of independent region scoring, according to some embodiments of the invention;

FIG. 9 is block diagram depicting an example of computing regional scores based on previous computations, according to some embodiments of the invention;

FIG. 10 is a flow diagram, depicting a method of conducting a vehicle by at least one processor, according to some embodiments of the invention; and

FIG. 11 is a flow diagram, depicting another method of conducting a vehicle by at least one processor, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

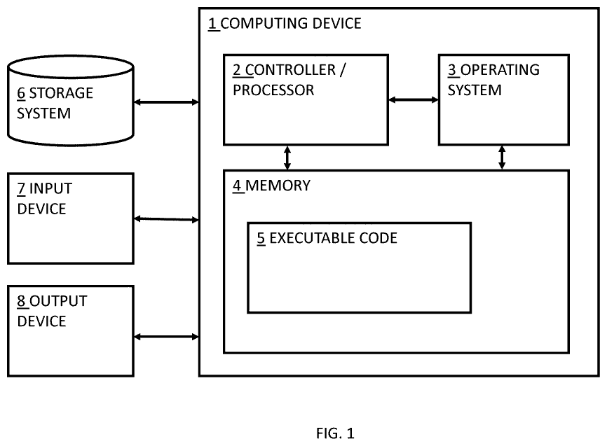

Reference is now made to FIG. 1, which is a block diagram depicting a computing device, which may be included within an embodiment of a system for assessment of sensor performance, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task or script. Executable code 5 may be executed by processor or controller 2 possibly under control of operating system 3. For example, executable code 5 may be an application that may assessment of sensor performance as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data from one or more spatial sensors may be stored in storage system 6 and may be loaded from storage system 6 into memory 4 where it may be processed by processor or controller 2. In some embodiments, some of the components shown in FIG. 1 may be omitted. For example, memory 4 may be a nonvolatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse, one or more spatial sensors (e.g., cameras) and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

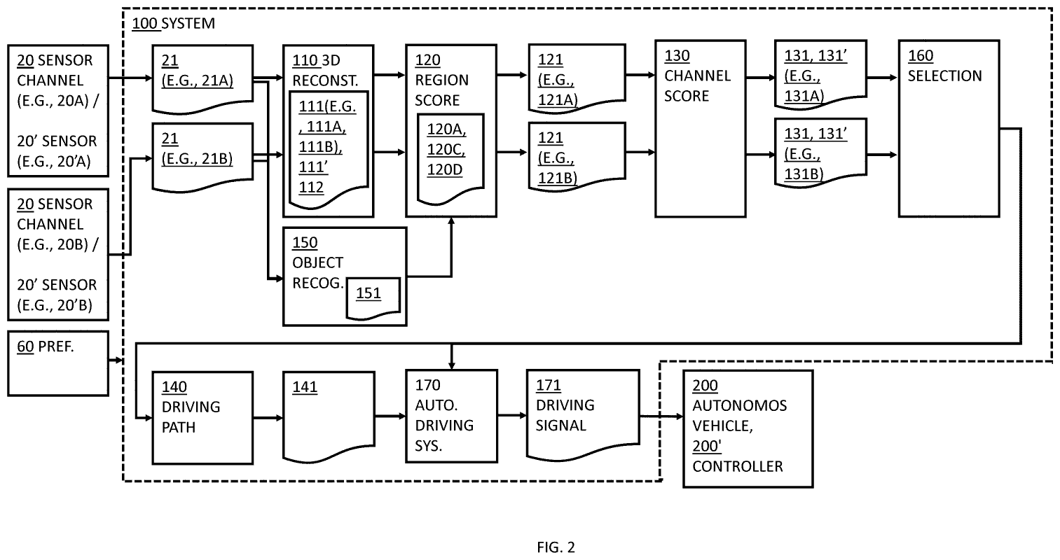

Reference is now made to FIG. 2, which depicts an example of a system for assessment of sensor performance, according to some embodiments. In the non-limiting implementation example of FIG. 2, system 100 may be configured to conduct or control movement of an autonomous vehicle 200 such as an autonomous car, an autonomous drone, and the like. It may be appreciated by a person skilled in the art that additional applications of system 100, by which assessment of performance of spatial sensors may also be possible.

According to some embodiments of the invention, system 100 may be implemented as a software module, a hardware module or any combination thereof. For example, system 100 may be or may include a computing device such as element 1 of FIG. 1, and may be adapted to execute one or more modules of executable code (e.g., element 5 of FIG. 1) to assess performance of spatial sensors, select one or more specific sensors based on the assessment, and act upon information originated from the selected sensors, as further described herein.

As shown in FIG. 2, arrows may represent flow of one or more data elements to and from system 100 and/or among modules or elements of system 100. Some arrows have been omitted in FIG. 2 for the purpose of clarity.

The example of FIG. 2 shows a system 100 with two sensor channels 20. For each channel, a 3D reconstruction may be created using for example stereo-depth, structure from motion, or any other method as known in the art. System 100 may produce a 3D reconstruction 111 or depth estimation map for each channel, using data exclusively from its sensors. 3D reconstruction 111 may then be scored as elaborated herein and the higher scored channel 20 may be selected as preferred. Computations toward the system's objective (e.g., conducting an autonomous vehicle) may allocate more resources to data gathered from the preferred channel's 20 sensors. Also, a user interface (e.g., elements 7 and 8 of FIG. 1) may change according to the preferred channel decision.

According to some embodiments of the invention, system 100 may assess and compare performance of different sensor channels 20 (e.g., 20A, 20B) which may be or may include sensors 20′ (e.g., 20′A, 20′B) of different types.

For example: sensor channel 20A may include two sensors 20′A such as VL cameras. VL cameras 20′A may be arranged in a stereoscopic configuration, adapted to produce a 3D reconstruction (e.g., a depth map) of a real-world object or scene in the VL spectrum. Sensor channel 20B may include two sensors 20′B such as IR cameras. IR cameras 20′B may be arranged in a stereoscopic configuration, adapted to produce a 3D reconstruction (e.g., a depth map) of a real-world object or scene in the IR spectrum. Other configurations of sensor channels 20, having spatial sensors 20′ adapted to produce a 3D reconstruction of the real world are also possible.

As shown in FIG. 2, system 100 may receive data 21 (e.g., 21A, 21B) from a plurality of sensor channels 20 (e.g., 20A, 20B respectively). For example, in an implementation of conducting an autonomous vehicle 200, system 100 may receive data 21 such as images of a surrounding scene from sensor channels 20 or sensors 20′ such as stereoscopic cameras or LIDAR sensors, associated with, or mounted on the autonomous vehicle 200.

According to some embodiments, sensor data 21 may be exclusive for each sensor channel. For example, system 100 may receive spatial sensor data 21 from a plurality of sensors 20′ that may each be associate with, or attributed to a unique sensor channel 20 (e.g., 20A or 20B). Additionally, or alternatively, sensor data 21 may not be exclusive among sensor channels. For example, system 100 may receive spatial sensor data 21 from a plurality of sensors 20′ where each sensor 20′ may be associated with one or more (e.g., a plurality) of sensor channels 20 (e.g., 20A and 20B).

As sown in FIG. 2, system 100 may include a 3D reconstruction module 110, adapted to perform a process of 3D reconstruction based on data 21, as known in the art. In some embodiments, 3D reconstruction module 110 may be configured to calculate, for each sensor channel 20 (e.g., 20A, 20B) a corresponding 3D reconstruction data element 111 (e.g., 111A, 111B respectively). 3D reconstruction data element 111 may also be referred to herein as a depth estimation map.

According to some embodiments, system 100 may include a channel scoring module 130, adapted to calculate a channel score 131 (e.g., 131A, 131B) for at least one (e.g., each) channel 20 based on the 3D reconstruction data element 111 of the respective channel, as elaborated herein. In other words, 3D reconstruction data element 111 may, for example be a depth map or a point cloud, representing real-world spatial information of an object and/or a scene, and system 100 may assess or compare performance of different sensors channels 20 or sensor types based on the produced 3D reconstruction data element 111, as elaborated herein.

According to some embodiments, system 100 may include a region score module 120, adapted to segment, or divide 3D reconstruction data element 111 to a plurality of areas or regions 120A corresponding to individual real-world objects or regions. For example, 3D reconstruction data element 111 may be a 2D depth map, and regions 120A may be regions of fixed size (e.g., single pixels or predefined windows) within the depth map. According to some embodiments, region score module 120 may calculate a region score 121 for each region 120A of 3D reconstruction data element 111, and channel scoring module 130 may aggregate the region scores 121 to produce channel score 131. For example, channel scoring module 130 may sum or accumulate the region score values 121 of a specific 3D reconstruction data element 111 originating from a specific channel 20, to produce a channel score 131 corresponding to the specific channel 20. In another example, channel scoring module 130 may apply another mathematical function (calculate a weighted sum, calculate a maximal value, calculate an average value, calculate a weighted average value) on region score values 121 of 3D reconstruction data element 111, to produce channel score 131 of the relevant channel 20.

According to some embodiments, region score module 120 may calculate a region score 121 for each region 120A of 3D reconstruction data element 111 based on a relevance map 120C.

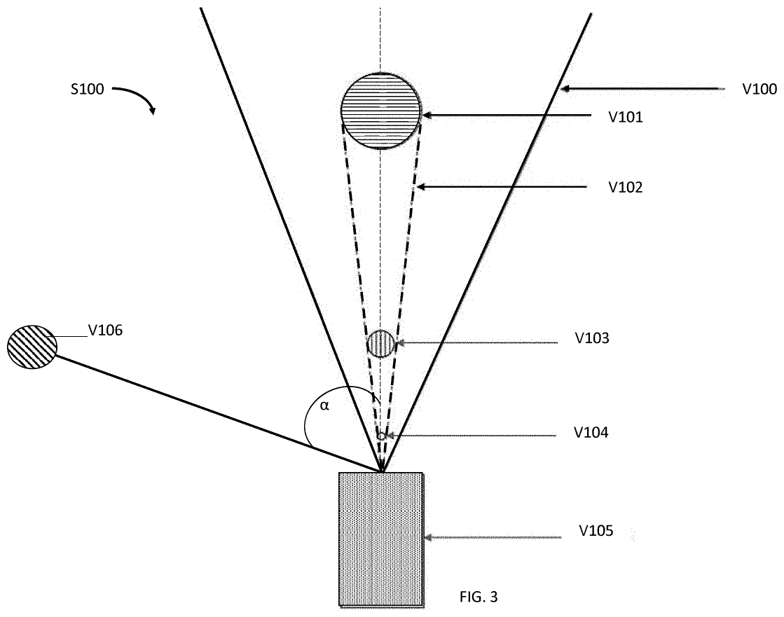

Reference is also made to FIG. 3 which is a schematic drawing depicting a top view of a scene S100 where multiple objects (e.g., V101, V103 and V104) are in the field of view V100 of an observer V105.

Due to their locations, objects V101, V103 and V104 may occupy the same view angle V102 in a 2D image taken from the observer's V105 point of view, and may therefore seem to be of the same size. As shown in FIG. 3, given a distance or depth value for each object V101, V103 and V104, embodiments of the invention may be able to assess the objects' real-world size. Embodiments of the invention may categorize objects according to relevance, based on (a) their distance from the observer, (b) their angular position in relation to the observer V105, and/or (c) an estimation of their real-world size.

For example, consider the example implementation of FIG. 2, where system 100 is configured to conduct autonomous vehicle 200. In such an example, observer V105 may be a sensor located on autonomous vehicle 200. Object V101 may be very large and far, e.g., a mountain in the background of a scene, and may therefore be categorized as irrelevant, or hardly relevant to the system's interest or task of conducting autonomous vehicle 200. In another example, object V104 may be very close and small (e.g., a bee, flying in the foreground) and may therefore be hardly relevant as well. In another example, object V103 (e.g., a first pedestrian) may be of medium size and distance from observer V105, and therefore may be categorized as having critical importance to the system's interest or task of conducting the autonomous vehicle 200. In yet another example, object V106 (e.g., a second pedestrian) may be of mid-range distance, and have mid-range size, but may also have an orientation or angular position a that may render it irrelevant for the task of conducting autonomous vehicle 200. In other words, pedestrian V106 may be located in angle α in relation to a predefined, forward-facing axis (e.g., a direction of motion) of observer V105, and may impose no impediment for conducting autonomous vehicle 200, and may therefore be regarded by embodiments of the invention as having low relevance to the task of conducting autonomous vehicle 200.

According to some embodiments, region scoring module 120 may initially calculate a region score 121 of a region 120A of 3D reconstruction 111 according to the following formula: Min(estimated area size 120D in m², estimated area size 120D in m² if the relevant object was 50 m away).

Region scoring module 120 may modify the initial score according to additional considerations, as elaborated in the following examples.

According to some embodiments of the invention, region scoring module 120 may attribute a relevance weight to objects based on their size, and/or location in the scene. For example, region scoring module 120 may produce or receive (e.g., via input device 7 of FIG. 1) a relevance map 120C that may associate or attribute a relevance score 121 to various areas or regions 120A of the scene as presented in 3D reconstruction data element 111. Objects (or portions thereof) located in areas 120A that are (a) attributed a high relevance score based on their distance and/or angular position a from observer V105, and (b) represent an estimated real-world size that is within a predefined relevance range may be assigned a high relevance weight or score 121. In another example, objects (or portions thereof) located in areas 120A that are (a) attributed a low relevance score based on their distance and/or angular position a from observer V105, or (b) have an estimated real-world size that is beyond the predefined relevance range (e.g., too small, or too large) may be assigned a low relevance weight or score 121.

In other words, region scoring module 120 may calculate a regional score 121 for one or more (e.g., each) individual area or region 120A 3D reconstruction data element 111. Region scoring module 120 may apply a weight to each regional score, based on characteristics of the relevant region. Such characteristics may include, for example: the system's interest of areas given their depth, size and/or angular position or orientation.

Additionally, or alternatively system 120 may include a machine-learning (ML) based object recognition module 150, adapted to recognize at least one object (e.g., a car, a person, etc.) based on the sensor data 21 (e.g., an image) and/or based on 3D reconstruction data element 111 (e.g., a depth map image), as known in the art.

According to some embodiments, system 100 may employ ML based model 150 to apply an object recognition algorithm on sensor data 21 and/or 3D reconstruction data element 111 and recognize at least one real-world object of interest. Region scoring module 120 may associate the at least one real-world object to one or more regions 120A of the 3D reconstruction data element and calculate region score 121 of a specific region 120A further based on the association of relevant regions with the at least one real-world object.

In other words, region scoring module 120 may calculate a regional score 121 for one or more (e.g., each) individual area or region 120A of 3D reconstruction data element 111 further based on association or labeling of the relevant regions to objects. This association or label is denoted as element 151 in FIG. 2. For example, in an implementation of conducting autonomous vehicle 200, region scoring module 120 may associate or label 151 one or more regions 120A to objects of interest (e.g., a pedestrian), recognized by object recognition module 150, and may attribute a relevance score based on association or label 151. In other words, if region 120A represents at least a portion of an object of interest (e.g., a pedestrian), then region scoring module 120 may attribute the relevant region 120A a high region score, based on its high level of relevance or interest. Alternatively, if region 120A represents a piece of foliage, then region scoring module 120 may attribute the relevant region 120A a low region score 121, based on its low level of relevance or interest.

According to some embodiments, region scoring module 120 may calculate a regional score 121 for one or more (e.g., each) individual area or region 120A of 3D reconstruction data element 111 further based on a real-world size value 120D represented by region 120A. For example, region scoring module 120 calculating, based on 3D reconstruction data element 111, a real-world size value 120D, representing a size of a real-world surface represented in the relevant region. For example, 3D reconstruction data element 111 may be a 2D depth map, and the real-world size value 120D may be, or may represent a size or area of a projection of a real-world surface in the direction of the sensor channel 20. In another example, 3D reconstruction data element 111 may be a 3D point cloud, and the real-world size value 120D may be or may represent a size or area of a surface of a real-world object represented in the point cloud. Region scoring module 120 may calculate regional score 121 based on the real-world size value and the relevance map. For example, regional score 121 of a region may be calculated as a number representing the area or size of the real-world surface presented in the region 120A, and weighted by the relevance score of that region in relevance map 120C.

According to some embodiments, 3D reconstruction module may produce a confidence value, or confidence score 112, that is a numerical value (e.g., in the range of [0, 1]) representing a level of confidence in producing 3D reconstruction data element 111, as known in the art. Confidence score 112 may be globally associated with the entirety of 3D reconstruction data element 111 or associated with one or more regions 120A of 3D reconstruction data element 111. In such embodiments, region scoring module 120 may calculate a regional score 121 for one or more (e.g., each) individual area or region 120A of 3D reconstruction data element 111 based on confidence level value 112.

For example, if a confidence level 112 of a specific region 120A or a 3D reconstruction data element 111 is low (e.g., 0.2), then regional score 121 of a corresponding region 120A may be weighted by the low confidence level 112, resulting in a low regional score 121. In another example, if a confidence level 112 of a specific region 120A or a 3D reconstruction data element 111 is below a predefined threshold value (e.g., 0.1), then regional score 121 of a corresponding region 120A may be assigned a ‘0’ value.

Alternatively, if a confidence level 112 of a specific region 120A or a 3D reconstruction data element 111 is high (e.g., 0.9), then regional score 121 of a corresponding region 120A may be weighted by the high confidence level 112, resulting in a high regional score 121.

As elaborated herein, channel scoring module 130 may calculate an overall channel performance score 131, representing performance or effectiveness of a channel 20 for providing information that is pertinent to the specific interest of system 100. Channel performance score 131 (e.g., 131A, 131B) may be calculated as an aggregation (e.g., summation, averaging, maximization) of regional scores 121 (e.g., 121A, 121B respectively) of 3D reconstruction 111 (e.g., 111A, 111B respectively).

According to some embodiments, system 100 may include a selection module 160, adapted to iteratively (e.g., repeatedly over time) compare channel performance scores 131 of a plurality of channels 20, and select at least one an optimal channel. The term “optimal” may be used in this context as relating to one or more selected, or preferred channels 20, corresponding to the best (e.g., highest scoring) channel performance scores 131 among the plurality of channels 20, within a specific iteration or time-frame. System 100 may then focus computational resources (e.g., allocate processing units, computing cycles, memory and/or storage) on data 21 gathered from sensors 20′ of the selected sensor channel 20 or sensor type, as elaborated herein.

According to some embodiments, given multiple sensors 20′ of different types, system 100 may attempt to perform 3D reconstruction with each sensor type or sensor set 20 individually. Each 3D reconstruction may be used to assess a channel performance score 131, which may be attributed to a sensor channel 20 as a whole, or individually to each sensor 20′ in the sensor channel 20. By comparing channel performance scores 131, the most relevant sensor channel and/or type may be chosen.

As elaborated herein, channel performance score 131 may, for example be computed by scoring each area 120A in the 3D reconstruction data element and summing the results. The scoring of an area 120A may be performed according to the system's interest in spatial characteristics of real-world objects represented by region 120A. Such spatial characteristics may include, for example depth (e.g., distance from observer V105 of FIG. 3), real-world size 120D value and orientation or angular position (e.g., denoted as a in FIG. 3).

According to some embodiments, a region 120A that is clearly mapped (e.g., corresponds to a high confidence level 112) in depth estimations of 3D reconstruction 111 by two sensor types or channels 20 may contribute similar channel performance scores 131 to both channels 20, due to similar depth, size and orientation or angular position values. An area that was unsuccessfully mapped by one sensor type or channel 20 (e.g., corresponds to a low confidence level 112) may not contribute to the channel performance score 131 of that channel 20. Therefore noise, saturation, fogy vision, and other image artifacts that make the 3D reconstruction more likely to fail may reduce the expected channel performance score 131.

For example, in a scene partly filled with fog, a first sensor channel 20A that includes sensors 20′A of a first type may be able to clearly see through the fog, and a second sensor channel 20B that includes sensors 20′B of a second type may not be able do so. In this condition, the foggy area 120A observed in the scene may contribute more to the channel performance score 131A of the first channel 20A, than to the channel performance score 131B of the second channel 20B. This contribution may make it more likely that channel 20 be scored higher than channel 20B.

Other artifacts may originate from bad calibration, and may cause a similar effect by causing depth estimation confidence to be low for specific channels 20. Furthermore, instability of depth estimations in some areas or less reliable 3D reconstruction may be given lower weight in their score contributions than clear, reliable ones. Therefore, selection module 160 may apply a bias function to compare between channel performance scores 131 of different channels 20, while compensating for such sensor artifacts.

Additionally, or alternatively, selection module 160 may receive (e.g., via input device 7 of FIG. 1) a user preference score 60. User preference score 60 may, for example be a numerical value (e.g., in the range of [0, 100]) that may represent a user's preference of a specific channel 20 and/or sensor 20′. Selection module 160 may apply a bias function on the channel scoring 131 of one or more channels 20, based on user preference score 60 to enforce selection of specific channels 20 according to the user's preference. Additionally, or alternatively, selection module 160 may apply a bias function on a quality score 131′ of one or more sensors to enforce selection of specific sensors 20′ according to the user's preference.

For example, a user may set a user preference score 60 of a specific region 120A of 3D reconstruction 111 of a first channel 20 to be 80, and set a user preference score 60 of that region 120A of a second channel 20 to be 40. In such embodiments, selection 160 may collaborate with channel scoring module 130, to apply a bias function (e.g., apply a double weight for the relevant region 120A in the 3D reconstruction 111 of the first channel 20), to manifest the user's preference.

In real time this method may assess and compare the relevance between sensors 20′ and/or sensor channels 20 in order to efficiently allocate computational resources. For example, a vehicle navigation system may be adapted to use a multiple spectrum sensor such as the Quadsight sensor set. Such a set may include a pair of sensors sensitive to a visible light spectrum, which may be referred to herein as a first, VL sensor channel, and a second pair of sensors, sensitive to an infra-red spectrum, which may be referred to herein as a second, IR sensor channel. Selection module 160 may iteratively select, for each time frame, a sensor channel 20 based on the channels' channel performance scores 131, to allocate data analyzing resources between the sensor types or channels, of which one may be redundant. In other words, selection module 160 may allow system 100 to compute or perform system 100's objectives (e.g., conduct an autonomous vehicle), while allocating more computing resources to data 21 originating from the preferred or selected channel 20.

As shown in FIG. 2, system 100 may include a driving path module 140, adapted to compute a driving path 141 based on 3D reconstruction data element 111 of the selected channel 20, and/or based on input data element 21 of the selected channel 20.

For example, 3D reconstruction data element 111 may be a point cloud depicting a portion of a road, and driving path module 140 may be configured to calculate a driving path 141 that is consistent with a predefined trajectory or direction of the road.

In another example, 3D reconstruction data element 111 may be a depth map which may include, or represent one or more objects or obstacles located in the vicinity of the vehicle, e.g., along a direction of a portion of a road. Driving path module 140 may be configured to calculate a driving path 141 that avoids collision with these objects or obstacles (e.g., cars, pedestrians, garbage cans, etc.) that may be also located on the portion of the road.

In yet another example, input data element 21 of the selected channel 20 may be an image obtained from a camera sensor 20′. As elaborated herein, ML-based object recognition module 150 may identify at least one object (e.g., cars, pedestrians, etc.) that may be depicted in image 21, and may classify image 21 as containing the identified object. Driving path module 140 may be configured to subsequently calculate a driving path 141 according to the classification of data element 21 (e.g., the image). For example, driving path 141 may include a definition of a property of motion (e.g., maximal speed) based on classification of the image (e.g., in the vicinity of other cars or pedestrians).

According to some embodiments, driving path 141 may include, for example, a series of numerical values, representing real-world locations or coordinates in which autonomous vehicle 200 may be planned to follow or drive through.

According to some embodiments, and as depicted in FIG. 2, system 100 may include a computerized autonomous driving system 170, adapted to control at least one property of motion of autonomous vehicle 200. Alternatively, system 100 may be communicatively connected, by any appropriate computer communication network to autonomous driving system 170, such as an autopilot system that may be associated with or included in autonomous vehicle 200. According to some embodiments, driving path module 140 may send driving path data element 141 to the computerized autonomous driving system 170 (e.g., via the computer communication network), and computerized autonomous driving system 170 may conduct, or control motion of autonomous vehicle 200 based on driving path 141.

Autonomous driving system 170 may be configured to produce a driving signal 171 that may be or may include at least one command for a controller 200′ (such as controller 2 of FIG. 1) of autonomous vehicle 200 based on driving path 141. Signal 171 may configure or command controller 200′ to adapt or control at least one property of motion of autonomous vehicle 200. For example, the property of motion may be a speed of autonomous vehicle 200, and signal 171 may command controller 200′ to adjust a position of a throttle of autonomous vehicle 200, so as to control the vehicle's speed according to the driving path. In another example, the property of motion may be a steering direction of autonomous vehicle 200, and signal 171 may command controller 200′ to adjust a position of a steering wheel or gear of autonomous vehicle 200, so as to control the vehicle's steering direction according to the driving path. Additional examples of properties of motion may include, for example acceleration, deceleration, orientation, pose and elevation of autonomous vehicle 200.

Thus, system 100 may be configured to conducting autonomous vehicle 200 by (a) selecting a sensor channel 20 of the plurality of sensor channels 20, based on channel score 131; and (b) conducting autonomous vehicle 200 based on the 3D reconstruction data element 111 of the selected sensor channel 20.

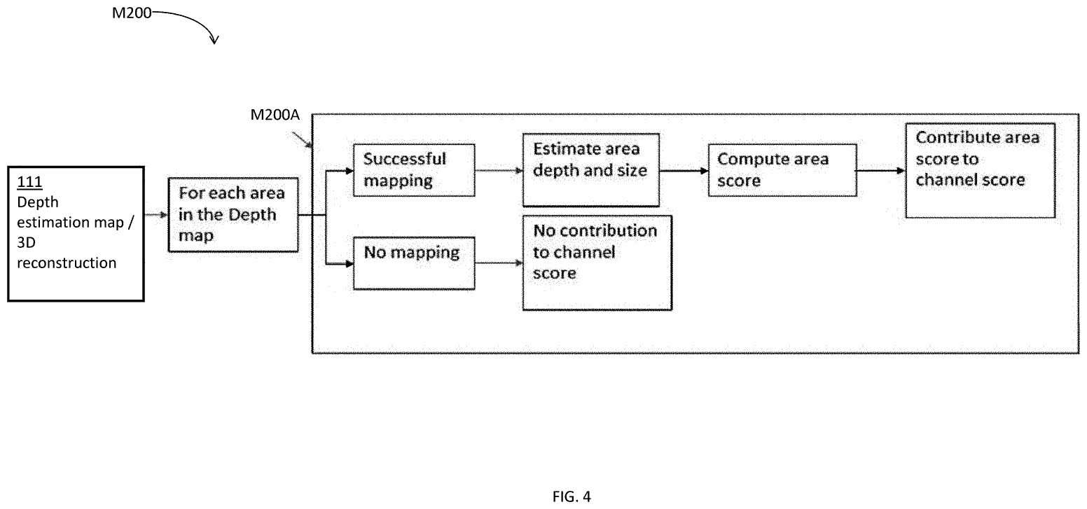

Reference is now made to FIG. 4 which is a flow diagram, depicting a method M200 of 3D reconstruction by system 100 of FIG. 2, according to some embodiments of the invention.

According to some embodiments, system 100 may split the process of 3D reconstruction into different areas or regions 120A, each used as input to the flow described in M200A.

An area 120A with a reliable depth estimation may be assessed a size as well (as seen in FIG. 2). The area 120A may be scored according to the system's interest, given its depth, size and angular position or orientation. 3D reconstruction 111, and the channel 20 that was used to construct it, may be scored by the sum of the area scores 120A computed. Channel score 131 may be attributed to the sensor channel 20 as a whole or individually to its sensors' 20′. Channel score 131 may represent the channel's relevance to the underlying task, and/or the channel's performance.

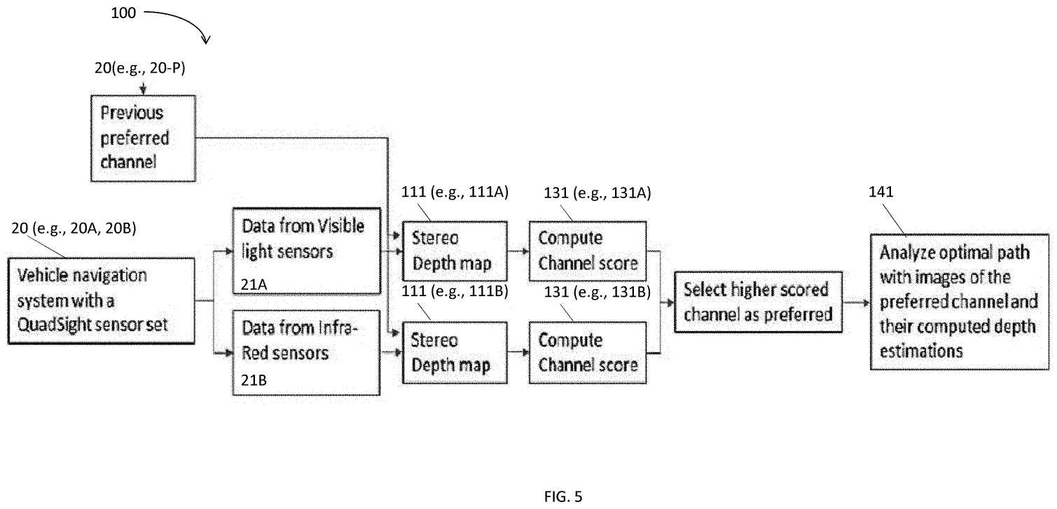

Reference is now made to FIG. 5 which is a block diagram depicting an example of integration of the system 100 for multiple sensor performance assessment with a sensor system that includes multiple spectrum sensors such as the Quadsight sensor set, according to some embodiments of the invention.

As shown in the example of FIG. 5, the flow of data depicts integration of the proposed channel scoring method to a sensor system using a QuadSight sensor set. The QuadSight sensor set may include two sensor channels 20: a first sensor channel 20 (e.g., 20A) may include two VL (Visible Light) cameras, and a second channel 20 (e.g., 20B) may include two IR (InfraRed) sensitive cameras.

The VL and IR cameras may be considered as two unique sensor channels, each adapted to compute a 3D reconstruction 111 (e.g., a stereo depth map), for example by using stereo-depth algorithms.

According to some embodiments, system 100 may iteratively compare the channel score 131 of channels 20A and 20B (e.g., 131A, 131B respectively), and may use data only from the more relevant channel (e.g., having the superior channel score 131) and its 3D reconstruction 111, to compute an optimal path 141. In other words, system 100 may selecting a sensor channel 20 iteratively, where each iteration pertains to a specific time frame. In each time frame the autonomous vehicle 200 may be conducted based on the 3D reconstruction data element 111 of the selected sensor channel 20 in that time frame.

According to some embodiments, in each iteration, system 100 may presume that a previously preferred channel 20 (e.g., either 20A or 20B, denoted as 20-P) may be more likely to be preferred in the current iteration. Therefore, when computing 3D reconstruction 111, system 100 may allocate more computing resources (e.g., computing cycles, memory, etc.) to create an accurate 3D reconstruction 111 of previously preferred channel 20-P. In other words, at each time frame: (a) the 3D reconstruction data element 111 of the relevant selected sensor channel 20-P may represent real-world spatial information in a first resolution, and (b) the 3D reconstruction data element 111 of at least one other sensor channel 20 may represent real-world spatial information in a second, inferior resolution.

Thus, embodiments of the invention may include an improvement over currently available methods of conducting an autonomous vehicle by iteratively emphasizing the process of data from a selected channel, to produce an optimal driving path 141.

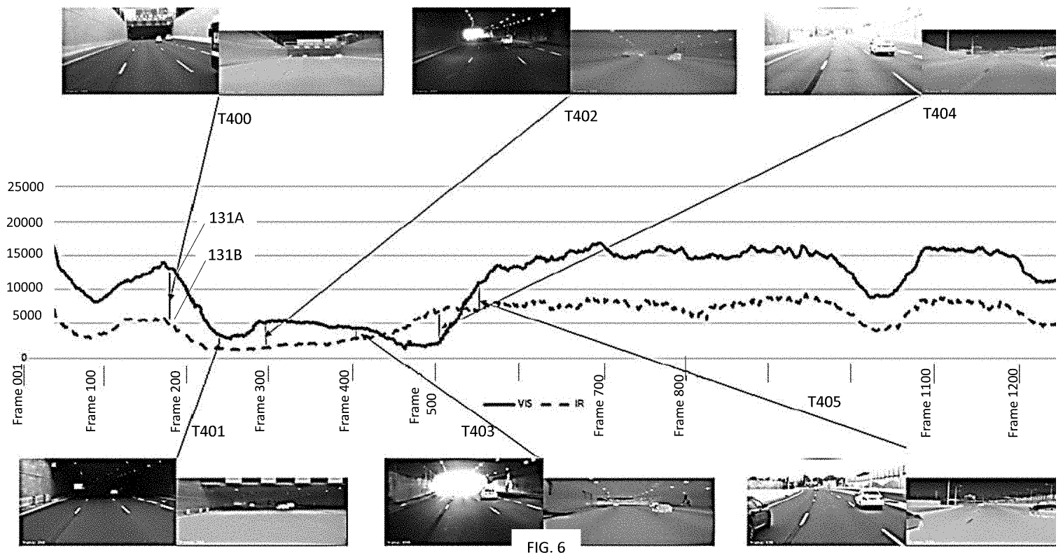

Reference is now made to FIG. 6 which is a timescale diagram, depicting scoring of a VL (Visible light) channel and an IR (infra-red) channel over time by system 100 of FIG. 2, according to some embodiments of the invention.

As shown in the example of FIG. 6, VL and IR cameras may be associated with, or mounted on autonomous vehicle 200. The VL and IR cameras may be continuously (e.g., repeatedly, over time) scored as two separate channels 20. Within the timeframe showed in the example of FIG. 6, vehicle 200 approaches and enters a tunnel (T400, T401 and T402), and then exists the tunnel (T403, T404 and T405). During most of that time the VL cameras shows higher channel scores (131A) and are assessed as the more relevant channel 20. However, roughly between frame 433 and 529, the IR channel score (131B) exceeds the VL channel score (131A), and is therefore assessed the most relevant. It is observable that during this timeframe a glare effect has blinded a small, but critical region 120A of the 2D images from VL cameras. The amount of data missing in the VL images is assessed by system 100 as critical. This area 120A exclusively adds a large value to the channel score 131B of the IR channel. Even though the glare area is only a small part of the 2D images, and many other areas may seem clearer in the VL images, the IR channel is selected as having superior performance in this timeframe.

Thus, during the period in which a glare appears in the VL images, system 100 may switch to conduct autonomous vehicle 200 based on 3D reconstruction 111 obtained from the IR channel 20.

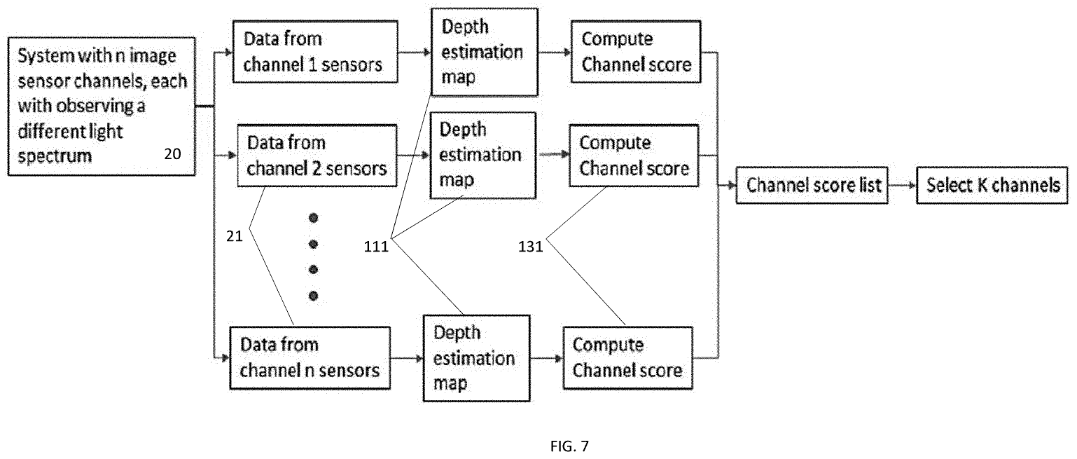

Reference is now made to FIG. 7 which is a block diagram depicting flow of data during a process of scoring multiple sensor channels by system 100 of FIG. 1, according to some embodiments of the invention.

The flow of data depicted in the example of FIG. 7 is similar to that elaborated herein, e.g., in relation to FIGS. 2 and/or 5, and will not be repeated here for the purpose of brevity. As shown in the example of FIG. 7, The 3D reconstruction (e.g., depth estimation map) 111 may be performed for each of the multiple channels 20. A channel score 131 may be computed for each channel 20. When comparing the scores, system 100 may prefer a single channel 20 for conducting autonomous vehicle 200. However, multiple best K channels (e.g., channels having the highest channel scores 131) may be chosen to perform high resolution 3D reconstruction of the real world scene.

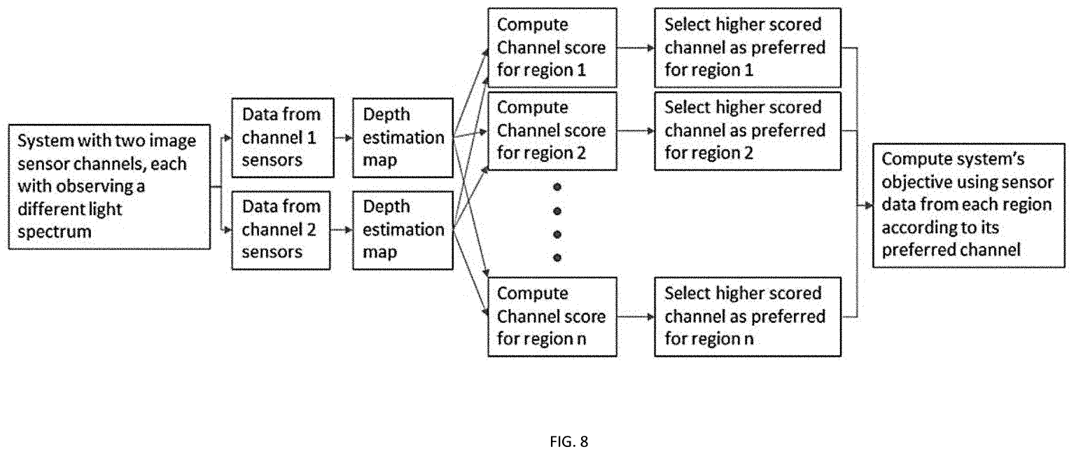

Reference is now made to FIG. 8 which is a block diagram depicting flow of data during a process of independent region scoring, according to some embodiments of the invention.

The flow of data depicted in the example of FIG. 8 is similar to that elaborated herein, e.g., in relation to FIGS. 2, 5 and/or 7, and will not be repeated here for the purpose of brevity. However, in the example of FIG. 8, the observed area observed may be split into multiple areas 120A which are scored and compared independently. This configuration may allow subsequent computations (e.g., computation of driving path 141 of FIG. 2) to use data 21 in each region 120A from the most relevant channel 20. For example, a vehicle navigation system may choose to split its view to ‘Left’ and ‘Right’ areas 120A, which may then be analyzed independently, each according to the data collected from the most relevant sensor type.

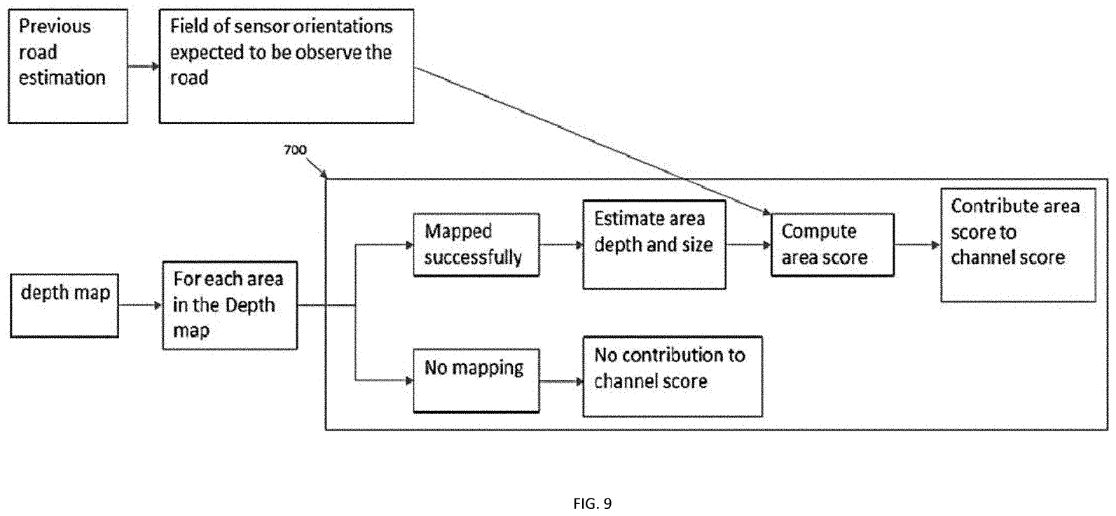

Reference is now made to FIG. 9 which is a block diagram depicting an example of computing regional scores 121 by system 100, based on previous computations, according to some embodiments of the invention.

The flow of data for computing a regional score 121 of a specific region 120A is similar to that elaborated herein, e.g., in relation to FIG. 4, and will not be repeated here for the purpose of brevity. However, in the example of FIG. 9, the function of computing a regional score 121 may be changed to dynamically value or weigh objects that are located at specific angular directions (e.g., angle α of FIG. 3) or orientations, in a precalculated field or range, more than objects that are located beyond that range. The term “dynamically” may be used in this context to indicate that preference of an angular direction may change over time, e.g., due to movement of autonomous vehicle 200 and/or movement of other objects in the scene (e.g., scene S100 of FIG. 3).

For example, system 100 may have recently calculated an optimal path 141, and automated driving system 170 may have controlled autonomous vehicle controller 200′ to conduct autonomous vehicle 200 according to that path 141. During motion of autonomous vehicle 200, system 100 may perform estimation of a field of view (e.g., a range of orientation a) that may sufficiently cover the calculated path 141 area. System 100 may update relevance map 120C to assign a higher relevance weight to regions 120A within the newly estimated field of view (FOV). It may be appreciated that such a scoring function may give more weight to selecting a channel 20 that is more relevant (has a higher regional score 121) in the specific area or FOV of interest. Additionally, or alternatively, system 100 may update relevance map 120C to assign higher weight to angular positions a or orientations that are expected to be associated with important objects (e.g., cars, pedestrians) recognized by object recognition module 150.

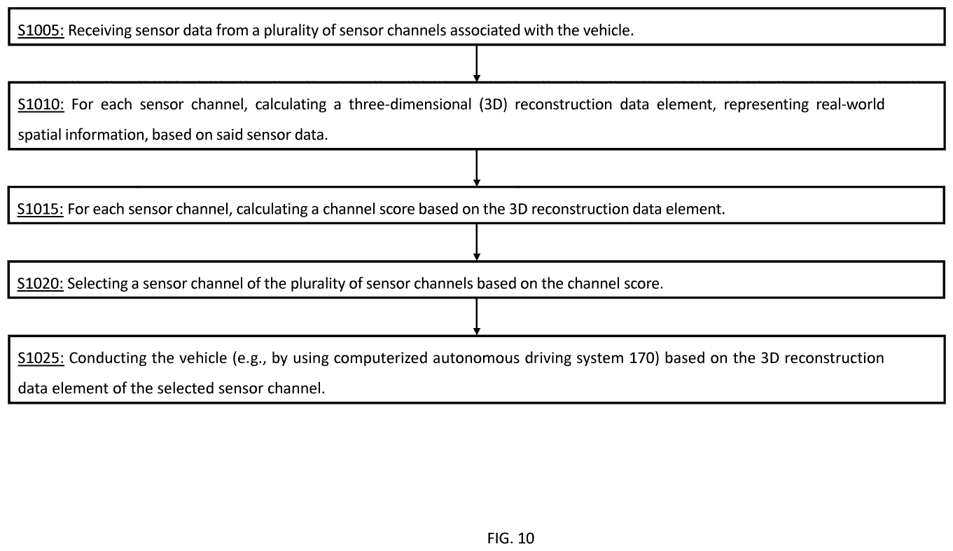

Reference is now made to FIG. 10, which is a flow diagram, depicting a method of conducting an autonomous vehicle (e.g., vehicle 200 of FIG. 2) by at least one processor, such as processor 2 of FIG. 1, according to some embodiments of the invention.

As shown in step S1005, the at least one processor 2 may receive sensor data (e.g., data 21 of FIG. 2) from a plurality of sensor channels (e.g., channels 20 of FIG. 2) associated with vehicle 200.

As shown in step S1010, for each sensor channel 20, the at least one processor 2 may calculate a 3D reconstruction data element (e.g., 3D reconstruction 111 of FIG. 2), representing real-world spatial information, based on said sensor data 21.

As shown in step S1015, for each sensor channel 20, the at least one processor 2 may calculate a channel score (e.g., element 131 of FIG. 2) based on the 3D reconstruction data element 111.

As shown in step S1020, the at least one processor 2 may select one or more sensor channels 20 (e.g., 20-P of FIG. 5) of the plurality of sensor channels 20 based on the channel score 131. For example, system 100 may receive spatial sensor data 21 from a plurality (e.g., 5) exclusive, or non-exclusive channels, and may select a predefined number (e.g., 1, 2) of channels based on channel score 131.

As shown in step S1025, the at least one processor 2 may conduct vehicle 200 (e.g., by using computerized autonomous driving system 170 of FIG. 2) as elaborated here (e.g., in relation to FIG. 2), based on the 3D reconstruction data element 111 of the selected or preferred one or more sensor channels 20.

Additionally, or alternatively, the at least one processor 2 may conduct vehicle 200 based on input data 21 of the selected channel (e.g., without using 3D reconstruction data element 111). For example, selection module 160 may perform selection of at least one preferred channel 20, and may notify this selection to autonomous driving system 170. Autonomous driving system 170 may be configured to use data 21 of the selected at least one preferred channel 20 to collaborate with a controller 200′ of autonomous vehicle 200, so as to conduct autonomous vehicle 200 based on data 21 of the selected at least one preferred channel 20.

For example, a single sensor channel 20 may be selected, and system 100 may proceed to compute a driving path 141 based on 3D reconstruction 111 of the selected channel 20.

In another example, a plurality of sensor channels 20 may be selected, corresponding to top-scored sensor channel scores 131. In such embodiments, 3D reconstruction module 110 may calculated a 3D reconstruction 111 data element that combines the 3D reconstruction 111 data elements of the plurality of selected channels 20. For example, 3D reconstruction module 110 may calculated a new 3D reconstruction 111 data element that is a weighted average of the plurality 3D reconstruction 111 data elements of the plurality of selected channels 20. The plurality 3D reconstruction 111 data elements may be weighted by the respective plurality of channel scores 131. System 100 may subsequently proceed to compute a driving path 141 based on the new, weighted average 3D reconstruction 111 of the plurality of selected channels 20.

In yet another example, system 100 may compute a driving path 141 based on one or more sensor data elements 21 of one or more selected sensors 20′ or sensor channels 20. For example, as elaborated herein (e.g., in relation to FIG. 2), system 100 may include an ML-based object recognition module 150, adapted to recognize and/or mark (e.g., by a bounding box) one or more objects depicted in a camera sensor 20′. According to some embodiments, driving path 140 may use the marked one or more objects (e.g., cars) in the image data 21 of camera sensors 20′, to compute driving path 141.

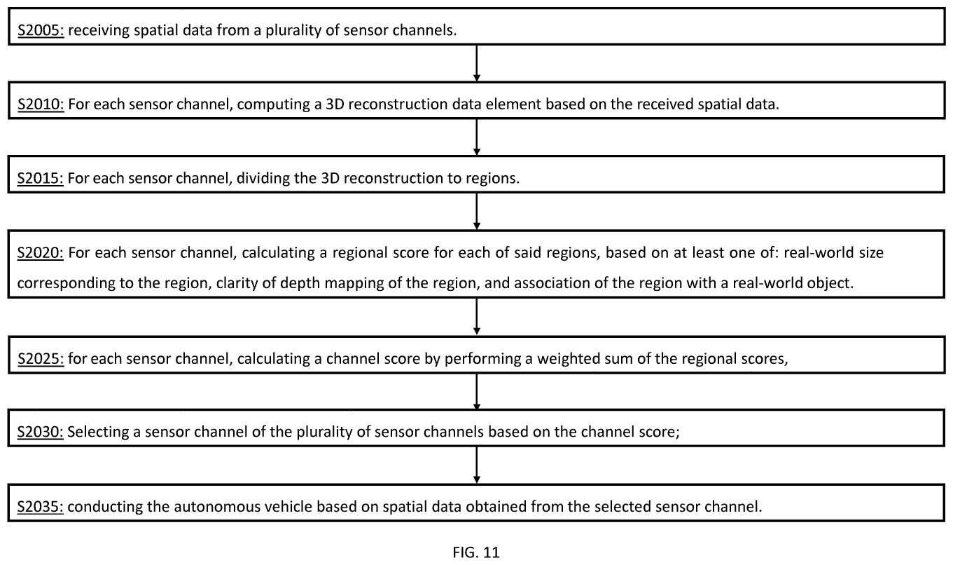

Reference is now made to FIG. 11, which is a flow diagram, depicting another method of conducting a vehicle by at least one processor, such as processor 2 of FIG. 1, according to some embodiments of the invention.

As shown in step S2005, the at least one processor 2 may receive spatial data 21 from a plurality of sensor channels 20.

As shown in step S2010, for one or more (e.g., each) sensor channel 20, the at least one processor 2 may compute a 3D reconstruction data element 111 based on the received spatial data 21.

As shown in step S2015, for one or more (e.g., each) sensor channel 20, the at least one processor 2 may divide the 3D reconstruction to regions 120A.

As shown in step S2020, for one or more (e.g., each) sensor channel 20, the at least one processor 2 may calculate a regional score 121 for each of said regions 120A. As elaborated herein, regional score 121 may be calculated based on an estimation of real-world size value 120D corresponding to region 120A. Additionally, or alternatively, regional score 121 may be calculated based on clarity, or a confidence level value 112 of depth mapping of the region. Additionally, or alternatively, regional score 121 may be calculated based on an association 151 of the region with a real-world object.

As shown in step S2025, for one or more (e.g., each) sensor channel 20, the at least one processor 2 may calculate a channel score 131. For example, the at least one processor 2 may calculate channel score 131 by performing a weighted sum of the regional scores 121.

As shown in steps S2030 and S2035, the at least one processor 2 may select at least one sensor channel 20 of the plurality of sensor channels based on the channel score, and may conduct the autonomous vehicle 200 based on this selection, as elaborated herein (e.g., in relation to FIG. 2).

For example, system 100 may use spatial data 21, obtained from a single selected sensor channel 20, to produce 3D reconstruction 111 data element. Driving path module 140 of FIG. 2 may subsequently use 3D reconstruction 111 data element to calculate driving path 141, and auto driving system 170 of FIG. 2 may collaborate with at least one controller 200′ of autonomous vehicle 200 to conduct autonomous vehicle 200 based on the calculated driving path 141.

In another example, system 100 may use spatial data 21, obtained from a plurality of sensor channels 20, selected according to their respective channel score 131 to produce corresponding 3D reconstruction 111 data elements. 3D reconstruction module 110 may compute a weighted average 111′ of 3D reconstruction data elements 111 of the selected at least one sensor channels 20, based on each channel's 20 respective channel score 131. Driving path module 140 of FIG. 2 may subsequently use weighted-average 3D reconstruction 111′ data element to calculate driving path 141, and auto driving system 170 may collaborate with at least one controller 200′ of autonomous vehicle 200 to conduct autonomous vehicle 200 based on the calculated driving path 141.

As elaborated herein, sensor channels 20 may include non-exclusive groups of sensors, wherein each sensor is associated with one or more sensor channels. For example, embodiments of the present invention may receive spatial sensory data from sensors A, B and C, and may select an optimal combination of sensors among sensors A, B and C. In such embodiments, a plurality of non-exclusive channels 20 may be defined. In this example, the non-exclusive sensor channels 20 of the invention may thus define three channels: a first sensor channel may include sensors A and B (e.g., denoted {A, B}), a second channel may include sensors A and C (e.g., denoted {A, C}), and a third sensor channel may include sensors B and C (e.g., denoted {B, C}). In such embodiments, evaluation of each of the non-exclusive sensor channels 20 may be done separately, based on the channels' 20 respective channel score 131 as elaborated herein. Channel scoring 130 may calculate a quality score 131′ for one or more individual sensors 20′ of at least one (e.g., each) sensor channel, based on the channel score of each sensor's respective channels. For example, for each combination of sensors 20′ forming a channel (e.g., channels {A, B}, {A, C} and {B, C}), each sensor 20′ may be attributed the channel score 131 that was calculated to that channel. Subsequently, an overall sensor quality score 131′ may be calculated, for each sensor 20′ as the sum of channel scores 131. Pertaining to this example, the sensor quality score 131′ of sensor A may be a sum of channel scores 131 of the channels {A, B} and {A, C}, and the sensor quality score 131′ of sensor B may be a sum of channel scores 131 of the channels {A, B} and {B, C}. Thus, channel score module 130 may individually calculate a quality score for individual sensors 20′ of at least one sensor channel 20. Selection module 160 of FIG. 2 may subsequently select one or more channels 20 and/or one or more individual sensors 20′ based on channel scores 131 and/or based on quality scores 131′ of individual sensors 20′.

Automated driving system 170 may proceed to conduct autonomous vehicle 200 based on spatial sensor data 21 of the selected at least one sensor 20′ and/or sensor channel 20, as elaborated herein.

Additionally, or alternatively, channel score module 130 may be configured to apply a bias function, adapted to compensate for sensor 20′ artifacts, on one or more sensor quality scores 131′. Thus, channel score module 130 may obtain a biased sensor quality score 131′. Selection module 160 may subsequently compare between two or more sensor quality scores 131′ and/or biased sensor quality scores 131′, of two or more respective sensors to select at least one sensor 20′ and/or sensor channel 20 based on this comparison. As elaborated herein, system 100 may proceed to conduct autonomous vehicle 200 based on the selected at least one sensor 20′ and/or sensor channel 20.

Embodiments of the invention may include a practical application of conducting autonomous vehicles based on data from a selected sensor channel. Embodiments of the invention may include a plurality of improvements over currently available autonomous vehicle technology.

For example, as elaborated herein, system 100 may dynamically and iteratively produce 3D reconstruction of a scene and assess and compare performance of different sensor channels or sensor types based on quality of the 3D reconstruction, e.g., based on an understanding of the surrounding scene by each sensor channel.

Additionally, channel performance may be assessed by system 100 by calculating scores for sub-regions in the 3D reconstruction, according to the system's interest of areas, based for example on the regions' depth (e.g., distance from the observing sensor), size, angular position or orientation in relation to the observing sensor and/or association to objects of interest present in the scene. In other words, selection of a sensor channel by embodiments of the invention may take into account specific preferences and interests of a specific application, such as conducting an autonomous land vehicle, conducting an autonomous airborne vehicle, or any other implementation that utilizes spatial sensors.

Additionally, system 100 may subsequently conduct the autonomous vehicle based on data obtained from the selected channel, and/or from an aggregation of regions 120A of different channels, based on the channel scoring 131 and/or regional scoring 121. Thus, embodiments of the invention may iteratively perform the underlying task of conducting the autonomous vehicle using the optimal data at hand.

Additionally, system 100 may focus computational resources on data gathered from a selected sensor set or sensor type, to improve performance of a computing device adapted to conduct the autonomous vehicle, and obtain higher resolution 3D reconstruction models 111 from the temporally optimal or preferred sensor channels 20.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of conducting a vehicle by at least one processor, the method comprising:
receiving sensor data from a plurality of sensor channels associated with the vehicle;
for each sensor channel, calculating a three-dimensional (3D) reconstruction data element, representing real-world spatial information, based on said sensor data;
for each sensor channel, calculating a channel score based on the 3D reconstruction data element;
selecting a sensor channel of the plurality of sensor channels based on the channel score; and
conducting the vehicle based on the 3D reconstruction data element of the selected sensor channel.

2. The method of claim 1, wherein selecting a sensor channel is done iteratively, wherein each iteration pertains to a specific time frame, and wherein in each time frame the vehicle is conducted based on the 3D reconstruction data element of the selected sensor channel in that time frame.

3. The method of claim 2, wherein at each time frame: (a) the 3D reconstruction data element of the relevant selected sensor channel represents real-world spatial information in a first resolution, and (b) the 3D reconstruction data element of at least one other sensor channel represents real-world spatial information in a second, inferior resolution.

4. The method of claim 1, wherein conducting the vehicle comprises:
computing a driving path based on the 3D reconstruction data element of the selected sensor channel;
sending the driving path to a computerized autonomous driving system, adapted to control at least one property of motion of the vehicle; and
conducting the vehicle by the computerized autonomous driving system, based on said computed driving path.

5. The method of claim 4, wherein the at least one property of motion is selected from a list consisting of: speed, acceleration, deceleration, steering direction, orientation, pose and elevation.

6. The method of claim 1, wherein the 3D reconstruction data element is selected from a list consisting of a depth map and a point cloud.

7. The method of claim 1, wherein calculating a channel score comprises:
segmenting the 3D reconstruction data element to regions;
for each region, calculating a region score; and
aggregating the region scores to produce the channel score.

8. The method of claim 7, wherein calculating the region score comprises:
receiving a relevance map, associating a relevance score to one or more regions of the 3D reconstruction data element;
calculating, based on the 3D reconstruction data element, a real-world size value, wherein said real-world size value represents a size of a real-world surface represented in the relevant region; and
calculating the region score based on the real-world size value and the relevance map.

9. The method of claim 8, further comprising calculating, for one or more regions of the 3D reconstruction data element a confidence level value, and wherein calculating the region score of a specific region is further based on the relevant region's confidence level value.

10. The method of claim 8, further comprising:
applying a machine-learning (ML) based object recognition algorithm on the sensor data to recognize at least one real-world object; and
associating the at least one real-world object to one or more regions of the 3D reconstruction data element,
wherein calculating the region score of a specific region is further based on the association of relevant regions with the at least one real-world object.

11. The method of claim 1, wherein receiving sensor data from a plurality of sensor channels comprises receiving spatial sensor data from a plurality of sensors, wherein each sensor is associated with one or more sensor channels.

12. A system for conducting a vehicle, the system comprising:
a computerized autonomous driving system, adapted to control at least one property of motion of the vehicle;
a non-transitory memory device, wherein modules of instruction code are stored; and
at least one processor associated with the memory device, and configured to execute the modules of instruction code, whereupon execution of said modules of instruction code, the at least one processor is configured to:
receive sensor data from a plurality of sensor channels associated with the vehicle;
for each sensor channel, calculate a three-dimensional (3D) reconstruction data element, representing real-world spatial information, based on said sensor data;
for each sensor channel, calculate a channel score based on the 3D reconstruction data element;
select a sensor channel of the plurality of sensor channels based on the channel score; and
conduct the vehicle by the computerized autonomous driving system, based on the 3D reconstruction data element of the selected sensor channel.

13. The system of claim 12, wherein the at least one processor is further configured to select a sensor channel iteratively, wherein each iteration pertains to a specific time frame, and wherein in each time frame the vehicle is conducted based on the 3D reconstruction data element of the selected sensor channel in that time frame.

14. The system of claim 13, wherein at each time frame: (a) the 3D reconstruction data element of the relevant selected sensor channel represents real-world spatial information in a first resolution, and (b) the 3D reconstruction data element of at least one other sensor channel represents real-world spatial information in a second, inferior resolution.

15. The system of claim 12, wherein the at least one processor is further configured to conduct the vehicle by:
computing a driving path based on the 3D reconstruction data element of the selected sensor channel;
sending the driving path to a computerized autonomous driving system, adapted to control at least one property of motion of the vehicle; and
conducting the vehicle by the computerized autonomous driving system, based on said computed driving path.

16. A method for conducting a vehicle by at least one processor, the method comprising:
receiving spatial data from a plurality of sensor channels;
for each sensor channel:
computing a 3D reconstruction data element based on the received spatial data;
dividing the 3D reconstruction to regions;
calculating a regional score for each of said regions, based on at least one of: real-world size corresponding to the region, clarity of depth mapping of the region, and association of the region with a real-world object; and
calculating a channel score by performing a weighted sum of the regional scores;
selecting at least one sensor channel of the plurality of sensor channels based on the channel score; and
conducting the vehicle based on said selection.

17. The method of claim 16, wherein receiving spatial data from a plurality of sensor channels comprises receiving spatial sensor data from a plurality of sensors, wherein each sensor is associated with one or more sensor channels, and wherein the method further comprises:
calculating a quality score for one or more individual sensors based on the channel score of each sensor's respective channels;
selecting at least one sensor based on the calculated quality score; and
conducting the vehicle based on spatial sensor data of the selected at least one sensor.

18. The method according to claim 17, wherein selecting a sensor channel comprises:
applying a bias function, adapted to compensate for sensor artifacts, on one or more sensor quality scores, to obtain a biased sensor quality score;
comparing between two or more sensor quality scores and/or biased sensor quality scores; and
selecting a sensor channel based on said comparison.

19. The method of claim 16, further comprising:
computing a weighted average of 3D reconstruction data elements of the selected at least one sensor channels, based on the channel scores;
computing a driving path based on the weighted average of 3D reconstruction data elements; and
conducting the vehicle according to the computed driving path.
